(19) United States
(12) Patent Application Publication
(10) Pub. No.: US 2003/0231164 A1
(43) Pub. Date: Dec. 18, 2003

(54) Keyboard controlled and activated pointing device for use with a windowing system display

(76) Inventors: Larry L. Blumer JR., Charlotte, NC (US); Adam E. Meggitt, Charlotte, NC (US); Jim T. Sauerwein, Charlotte, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/174,327

(22) Filed: Jun. 18, 2002

(51) Int. Cl. G09G 5/08

(52) U.S. Cl. 345/159

(57) ABSTRACT

The present invention provides for a keyboard controlled and activated windowing system pointing device that is typically implemented on a portable data terminal. The pointing device will typically be activated and deactivated by engaging an activation key on the portable data terminal. This allows for multifunctional keys to exist on the keyboard and for the cursor (i.e. the pointer) to be displayed and removed from the display upon activation. Additionally, the pointing device provides for scrolling of the foreground windowed application when the cursor encounters an edge of display. This allows users to access data in oversized windowed applications that do not fit the size limitations of portable data processing displays.

### FIELD OF THE INVENTION

The present invention relates generally to the field of pointing devices for use with a windowing system and, more particularly, the invention relates to a keyboard controlled and keyboard activated pointing device that it advantageous for use with portable data terminals having displays of limited size.

### BACKGROUND OF THE INVENTION

Portable data terminals and portable computing devices are becoming increasingly more and more prevalent in all facets of life. Portable computers, in the form of laptop computers, notebook computers, pocket or handheld computers and the like, have become an essential tool for the mobile businessperson. The advent of the personal digital assistant (PDA) has further accentuated the omnipresent demand and use of portable computing devices. In the same regard, portable data terminals, in the form of portable image scanning devices, portable bar code readers and the like, have become the preferred means of capturing and communicating data. Such portable data terminal devices allow the user to capture and/or receive data in a mobile environment as the application dictates.

As these portable devices become increasingly smaller in size, user demands have required more functionality to be incorporated in the device. For example, portable data terminals, such as image scanners or bar code readers, have become more intelligent devices that are capable of implementing, in a multitask environment, graphical user interface (GUI) operating systems, such as a windowing system. However, portable devices, especially handheld portable devices are limited in terms of display size and the means by which an associated pointing device can be implemented. These limitations can pose efficiency problems when the portable devices become equipped with windowing system capabilities.

Laptop and notebook computers have typically been able to eliminate the standard mouse-pointing device that is generally the chosen means of point-and-click in the desktop environment. The laptop and notebook devices typically have the keyboard space available to implement pointing devices in the form of touchpads, trackballs, pointing sticks or the like. However, in smaller handheld devices, in which keyboard space is typically at a premium, dedicated pointing devices are not advantageous in terms of space consumption. These smaller devices require a pointing device that will limit the amount of keyboard space utilization while still providing the user with an efficient means of pointing and sending commands to the windowing system.

In implementing a pointing device in a windowing system-based portable data processing device an additional concern is related to the functionality of the windowing system. Typical windowing systems include, Microsoft Windows, manufactured by the Microsoft Corporation of Redmond, Washington; Macintosh OS/2 manufactured by Apple Computer Incorporated of Cupertino, California; and Motif endorsed by the Open Software Foundation and typically the standard for UNIX and LINUX operating systems; and the like. These windowing systems typically operate in an environment in which applications are introduced to the user in a finite viewing area on the display. As the display area size decreases it becomes increasingly more difficult to access the information in a displayed window.

In conventional VGA displays 640 pixels by 480 pixels are displayed and the windowing system applications that are introduced to the user can typically be displayed in their entirety or options are available to maneuver, as need be, the windowed application. However, portable handheld devices have introduced displays as small as ¼ or ⅛ standard VGA. In these devices, windowed applications will typically be larger in area than the display itself and the user is left with no other option than continually repositioning the window, by a conventional “click and drag” process, to access the information in the window. This is a cumbersome and inefficient task and one that makes the functionality of the windowing system incompatible with most handheld devices.

A need therefore exists to develop a pointing device that can be implemented in handheld devices and provide the user with an efficient and effective means of pointing to objects on the display and sending commands to the windowing system. Such a pointing device should be unobtrusive and occupy limited area on the keyboard or face of the device. Additionally, a need exists to develop a pointing device that addresses the issues related to application window size and increasingly smaller displays. As such, the pointing device should provide for the ability to access the data in oversized windowed applications without continually having to move the window via a “click and drag” process to accommodate the small area of the display. By providing for a pointing device that is easy to activate, straightforward in operation and is capable of uncomplicated navigation of the displayed foreground window, the overall device will provide the user with an efficient means of operating a handheld device that implements a windowing system.

### SUMMARY OF THE INVENTION

The present invention provides for a keyboard controlled and activated windowing system, pointing device that is typically implemented on a portable data terminal. The pointing device will typically be activated and deactivated by engaging an activation key on the portable data terminal. This allows for multifunctional keys to exist on the keyboard and for the cursor (i.e. the pointer) to be displayed and removed from the display upon activation. By providing for pointing device activation means the keyboard area can be limited and an efficient means of providing pointing device capabilities is provided to the device user.

Additionally, the present invention provides for a pointing device that scrolls (i.e., pans) the entirety of a foreground window upon navigating the pointer to a predetermined location on the display. This aspect of the invention addresses the problem of oversized windowed applications being displayed on an undersized display typical of a portable handheld data processing unit. The scrolling feature of the present invention allows the device user to access information within the foreground window without having to continually move the application window about the display using a conventional “click and drag” process.

In one embodiment of the invention a portable data terminal that implements a windowing system includes a processing unit disposed in the portable data terminal, a keyboard having multiple keyboard elements in communication with the processing unit, and a display in communication with the processing unit that displays windowing system applications. The keyboard will include an activation means that activates/deactivates a windowing system application cursor on the display.

Additionally the activation means may activate/deactivate predetermined multifunctional keys on the keyboard for the purpose of controlling commands to the windowing system application cursor on the display. The portable data terminal may additionally include directional elements, typically arrow keys, that are activated by the activation key to control directional navigation of the cursor and command key(s) that are activated by the activation key to control pointing device commands, such as right-click and left-click commands of the pointing device. Typically, the control keys will include a first control key that controls left-click functions of a conventional pointing device and a second control key that controls right-click functions of a conventional pointing device. The portable data terminal of this embodiment may take the form of a portable imaging device, a portable bar code reader, a PDA or any other portable data processing terminal that implements a windowing system and requires cursor display and an associated pointing device.

In this embodiment of the invention, the directional elements may be provided such that they are capable of navigating the cursor to a predetermined location on the display to provide automatic scrolling of the entirety of the foreground window. Typically, this will involve navigating the cursor to an edge of the display, at which point, the foreground window will scroll so that the display can pan the windowed application. The directional elements may also be provided such that continual engaging of one of the directional elements will cause accelerated movement of the cursor on the display.

A further embodiment of the invention is a data processing system that includes a processing unit disposed within the data processing system and a display in communication with the processing unit that displays windowing system applications and displays an application cursor. In this embodiment, while the preferred system is a portable data processing system, the data processing system may include desktop data processing devices and the like. As such the processing unit may be housed in a portable data processing unit, a mainframe for a desktop data processing unit or the like. The display may be incorporated in a single handheld device or it may be an independent display terminal.

The system also includes a pointing device for directing the navigation of the cursor about the display. The pointing device may be keyboard operated arrow keys, a keyboard touchpad, a keyboard trackball, a keyboard pointing stick or a conventional auxiliary mouse-type device. This embodiment of the invention will also include a pointing device module implemented by the processing unit. The pointing device module provides the capability to automatically move the entirety of a foreground window when the pointing device navigates the cursor to a predetermined position on the display. In most embodiments of the invention the pointing device module will move the entirety of the foreground window when the cursor is navigated to an edge of the display. This function allows the user of the data processing system to pan the display around a windowed application. While this feature of the invention is highly beneficial to devices having smaller than standard display size, typically, portable data processing systems, it is also advantageous to other data processing systems, as well. Additionally, the pointing device module may include an acceleration routine to accelerate the navigation of the cursor upon enabling a keyboard command.

In another embodiment of the invention a pointing device module is provided for that is implemented in a windowing system-based data processing system and is used to control the navigation of a cursor on an associated display. The module includes means for navigating a cursor about the display, means for providing commands to the windowing system, and means for scrolling the entirety of a foreground window when the cursor is navigated to an edge of the display. Additionally, the module may comprise means for accelerating the navigation of the cursor about the display.

The invention is also defined in various methods for using the pointing device of the present invention. In one embodiment, a method for activating and navigating a windowing system cursor on a display of a portable data terminal includes the steps of engaging an activation means associated with the portable data terminal, activating a keyboard-based pointing device in response to engaging the activation means, activating a cursor on a data terminal display in response to engaging the activation means and keyboard-based pointing device directional element to navigate the cursor about the display. This method provides for a keyboard activated and keyboard controlled pointing device. Additionally this method may include the step of engaging, continuously, the directional element to accelerate the navigation of the cursor about the display or the method may include the step of engaging the directional element to navigate the cursor to a predetermined area of the display to invoke scrolling of the foreground window.

The invention is further embodied in a method for automatically scrolling the display of a foreground window on a display associated with a data processing system. The method includes the steps of navigating a cursor to a predetermined location on the display and scrolling, automatically, the entirety of a foreground window so as to pan the display around the foreground application window. Typically, the predetermined location will be an edge of the display, such that navigating the cursor to an edge of the display will prompt automatic scrolling of the entirety of the foreground application window.

The present invention provides for a pointing device that can be implemented in handheld devices and provides the user with an efficient and effective means of pointing to objects on the display and sending commands to the windowing system. By providing for a pointing device that is activated and deactivated on the keyboard, the pointing device of the present invention can minimize space occupancy on the keyboard or face of the device. The pointing device addresses the issues related to application window size and increasingly smaller displays, by implementing a novel scrolling routine that allows the user to access the data in oversized windowed applications without continually having to move the window to accommodate the small area of the display. The pointing device herein described is easy to activate, straightforward in operation and is capable of uncomplicated navigation of the displayed foreground window, as such the device provides the user with an efficient means of operating a handheld device that implements a windowing system.

### BRIEF DESCRIPTION OF THE DRAWINGS

FIG. 1 illustrates a plan view diagram of a portable data terminal having a keyboard controlled pointing device, in accordance with an embodiment of the present invention.

FIG. 2 illustrates a plan view diagram of a data processing system having a pointing device and associated pointing device module, in accordance with an embodiment of the present invention.

FIG. 3 illustrates a block diagram of a pointing device module that implements scrolling of oversized window applications, in accordance with an embodiment of the present invention.

FIG. 4 illustrates a flow diagram of the activation/deactivation module of a pointing device, in accordance with an embodiment of the present invention.

FIG. 5 illustrates a flow diagram of the cursor movement module for a pointing device, in accordance with an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

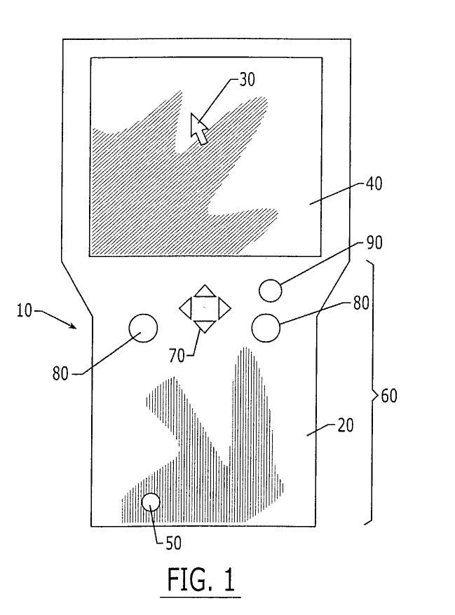

FIG. 1 illustrates a plan view (i.e., front face) diagram of a keyboard activated and controlled pointing device 10 implemented on a portable data terminal 20, in accordance with an embodiment of the present invention. The portable data terminal may be any portable data terminal device in which a pointing device is needed to navigate a cursor 30 on the display 40. By way of example, such portable data terminals include handheld imaging devices, handheld barcode readers, personal digital assistants and the like. Typically, a pointing device will be required if the portable data terminal implements a Graphical User Interface (GUI) operating system, such as a windowing system. Windowing Systems, such as Windows, Macintosh, Motif and the like, provide for applications to be displayed in a window format. A window format is a scrollable viewing area on a screen, typically a rectangular area, in which, the window is movable and resizable.

The pointing device 10 is activated by engaging an activation key 50 that is disposed on the portable data terminal. The activation key will also, typically, control the display of the cursor 30 on the data terminal display 40. The activation key is in communication with a processing unit (not shown in FIG. 1) that controls keyboard functions. In the embodiment shown in FIG. 1 the activation key is disposed on the keyboard portion 60 of the data terminal. In other embodiments of the invention the activation key may be disposed outside of the keyboard portion of the terminal, i.e., on any portion of the data terminal such as on a side face portion or the back face portion. The activation key may serve multi-functional purposes as required by the data terminal that it is associated with. For example a single tap on the activation key may be designated as a symbol keystroke while a double tap on the key may engage activation of the pointing device. The use of an activation key to activate the pointing device is shown by way of example only. Other means of activation other than an activation “key” may also be used without departing from the inventive concepts herein disclosed.

One or more directional elements, such as, arrow keys 70 are disposed on the keyboard portion 60 of the portable data terminal 20. Upon activation by the activation key 50, the one or more arrow keys serve to navigate the cursor 30 on the display 40. Conventionally the one or more arrow keys will comprise four arrow keys, one each, for the north, south, east and west direction. However, it also possible and within the inventive concepts herein disclosed for the arrow keys to comprise more or less than four keys. For example, the arrow key may be a single arrow key that directs the cursor in the north, south, east or west direction depending on the area of the key that is depressed (i.e., depressing the north area of the single arrow key moves the cursor in the north direction, depressing the south area of the single arrow key moves the cursor in the south direction, etc.). Alternatively, eight arrow keys may be provided to allow for cursor movement in diagonal directions across the display, i.e., arrow keys pointing in the north-west, north-east, south-east and south-west directions.

The one or more directional elements, such as, arrow keys 70 may be configured to provide for accelerated movement of the cursor 30 on the display 40. In this regard, the arrow keys may be configured such that depressing the key and holding it down will trigger acceleration of the cursor on the display. Other means of triggering acceleration in the cursor, in conjunction with activating one of the arrow keys, is also within the concepts of the present invention. Further details of the acceleration function of the pointing device are forthcoming in later detailed discussion.

Additionally, the one or more directional elements, such as, arrow keys 70 may be configured to provide scrolling of a foreground window application when the cursor is navigated 30 to a predetermined location on the display 40. Typically the predetermined location will be an edge of the display. In this regard the scrolling function provides for the display be to panned about the window to allow for the device user to access the information within the window without moving the window by a conventional “click and drag” process. In the small display environment of the present invention, the window may typically be oversized compared to the area of the display and, thus, the window can not be displayed in its entirety. Further details of the scrolling function of the pointing device are forthcoming in later detailed discussion.

The pointing device 10 of the present invention may also comprise one or more command keys, 80 and 90, which are disposed on the keyboard portion 60 of the portable data terminal. The command keys send commands to the graphical user interface in similar fashion to the right-click and left-click functions on a conventional auxiliary mouse. In this regard, the commands sent via the command keys will activate pull-down menus, select options from taskbars, downsize, upsize or close application windows, etc. In the embodiment shown in FIG. 1, command keys 80 provide, when engaged, the left-click functions of a conventional mouse and the command key 90 provides, when activated, the right-click functions of a conventional mouse. The command keys 80 and 90 are multifunctional, in that they provide for keyboard functions other than cursor device command keys when the activation key 50 has not been engaged. In the embodiment of FIG. 1, the command keys 80 provide left and right enter key functions when the cursor device has not been activated and the command key 90 provides a tab key function when the cursor device has not been activated. The alternative function of the command keys are shown by way of example only, the command keys can provide any other keyboard related function without departing from the inventive concepts herein disclosed.

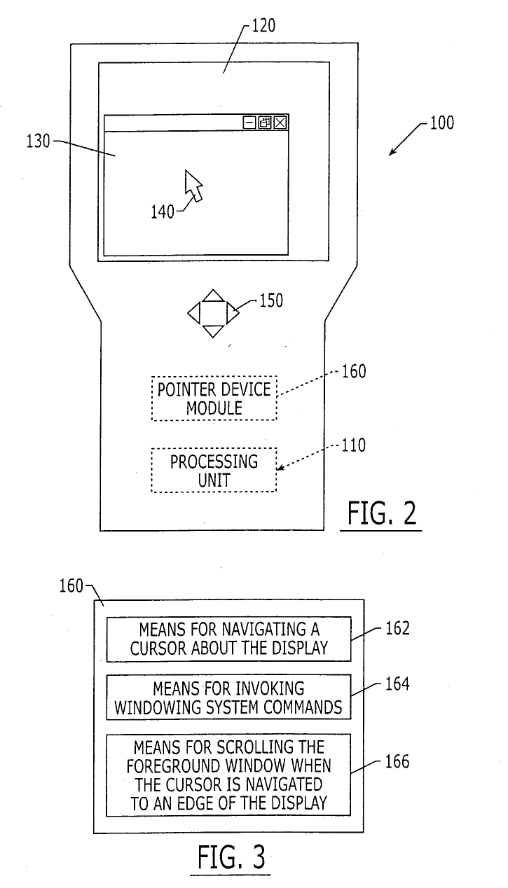

FIG. 2 is a plan view diagram of a data processing system, in accordance with an embodiment of the present invention. It should be noted that while the data processing unit shown is a handheld portable system, the data processing system of this embodiment of the invention includes other non-handheld and non-portable data processing systems, such as desktop data processing systems and the like. The data processing system 100 includes a processing unit 110 disposed within the data processing system. The processing unit may be physically housed in a portable data processing unit, a mainframe CPU or the like. The system also includes a display 120 in communication with the processing unit that displays windowing system applications 140 and displays an associated cursor 150 (i.e., pointer). The display may be may be incorporated in a single handheld device unit or it may be an independent display, such as the display associated with a desktop data processing system.

The system also includes a pointing device 160 for directing the navigation of the cursor 140 about the display 120. The pointing device may be a keyboard operated arrow key(s), a keyboard touchpad, a keyboard trackball, a keyboard pointing stick or a conventional auxiliary mouse-type device. This embodiment of the invention will also include a pointing device module 170 implemented by the processing unit 110. The pointing device module provides the capability to automatically scroll a foreground window when the pointing device navigates the cursor to a predetermined position on the display. In most embodiments of the invention the pointing device module will scroll the foreground window when the cursor is navigated to an edge of the display. This function allows the user of the data processing system to pan the display around a windowing system application window. This feature of the invention is highly beneficial to devices having smaller than standard display size, typically portable data processing systems, such as portable data terminals (PDTs) that do not incorporate touch screens. However, this feature is also advantageous to other data processing systems, as well.

Additionally, the pointing device module may include an acceleration routine to accelerate the navigation of the pointer upon enabling a keyboard command. Typically, the acceleration routine will be invoked by continuously engaging a means for directing the cursor, such as arrow key(s), touchpad, pointing stick or the like.

FIG. 3 is a block diagram of the pointing device module 160, in accordance with an embodiment of the present invention. The pointing device module will include means for navigating a cursor about the display 162. These means will be implemented by a user interfacing with the appropriate pointing device, such as a keyboard arrow keys, keyboard touchpad, a keyboard trackball, a keyboard pointing stick or a conventional auxiliary mouse-type device. The module will additionally include means for invoking windowing system commands 164. These means will be implemented by a user interfacing with the appropriate pointing device, such as keyboard command keys, or the right-click/left-click buttons on a conventional mouse. The module will also include means for scrolling the entirety of a foreground window 166 when the cursor is navigated to an edge of the display. These means allow the user to access information that is within the current windowed application but is outside of the viewable display area. This module is most advantageous in portable handheld data processing systems that have reduced displays, in particular, in PDT devices which do not incorporate touch screens. However, this module also serves a benefit in other data processing systems as a means for scrolling windows, in lieu of moving the window on the display by a conventional “click and drag” process.

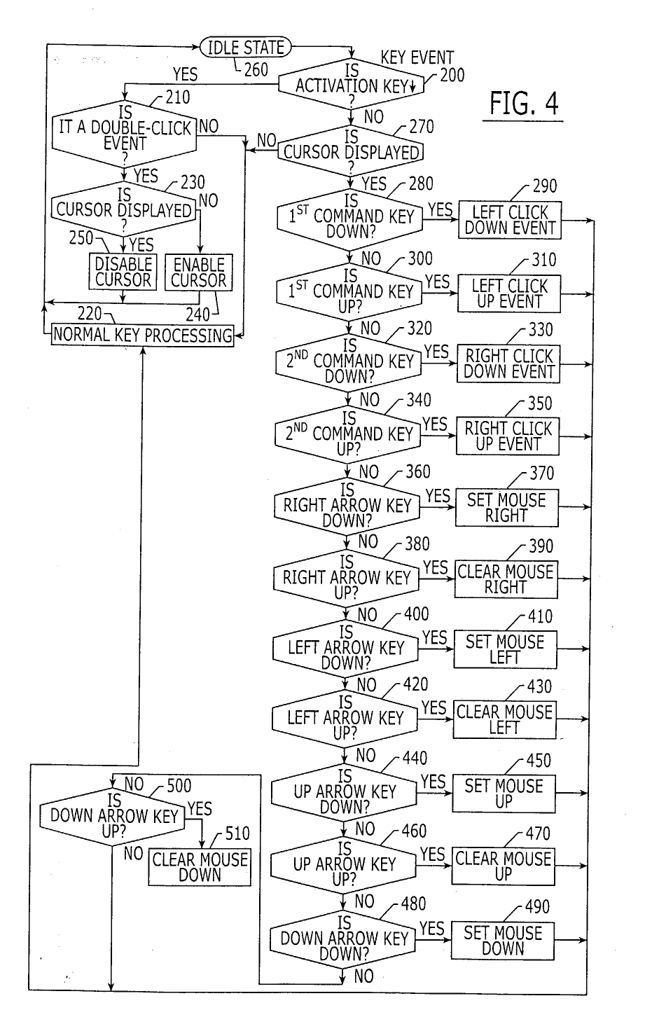

FIG. 4 is illustrative of a flow diagram of the logic flow for the activation/deactivation module for the pointing device, in accordance with an embodiment of the present invention. In this embodiment an activation key is required to activate the pointing device and display the cursor on the display. The activation/deactivation interrupt service module is initiated at step 200 where a key event triggers a determination of whether the key event is a depressing of the activation/deactivation key. If a determination is made that the activation/deactivation key is being depressed then, at step 210, a determination is made as to whether or not the depressing of the activation/deactivation key is a double tap (or double click) event. If the determination is made that the depressing of the activation/deactivation key is not a double tap event then, at stage 220, the module continues normal keystroke processing. If a determination is made that the depressing of the activation key is a double click event then a determination is made, at step 230, to determine if the double click event is an activation or a deactivation event. This determination is made by assessing whether the cursor is in an enabled state on the display. If a determination is made that the cursor is not enabled then, at stage 240, the pointing device and the cursor are enabled and the module returns to the idle state 260. If a determination is made that the cursor is enabled then, at stage 250, the pointing device and the cursor are disabled and the module returns to the idle state 260.

If at step 200, the key event is determined to not be a depressing of the activation/deactivation key then, at step 270, a determination is made as to whether the pointing device and the cursor are currently enabled. If a determination is made that the pointing device and the cursor are not currently enabled then the module returns, at stage 220, to normal keystroke processing. If a determination is made that the pointing device and the cursor are currently enabled then the module continues with flow to determine if the key event is pointing device related, i.e., is the key event related to one of the arrow keys or one of the command keys. For the purpose of the flow diagram of FIG. 4, we assume an embodiment of the invention similar to that shown in FIG. 1. As such the pointing device related to FIG. 4 has four arrow keys, designated as the right, left, up and down arrow keys and two command keys, the first command key associated with the enter key(s) and the second command key associated with the tab key.

The next four keystroke commands of the activation/deactivation interrupt service module (steps 280, 300, 320 and 340) are associated with command key directives that are similar to the right-click and left-click commands used with a conventional mouse pointing device. At step 280, a determination is made as whether the first command key is currently depressed (i.e., in a “down” state). In the embodiment of FIG. 1 the first command key is the left or right enter key that is activated to become the left-click command of a conventional mouse pointing device. If the determination is made that the first command key has been depressed then, at stage 290, the associated left click “down” event occurs.

If the determination is made that the first command key is not currently depressed then, at step 300, a determination is made as whether the first command key is currently depressed and released (i.e., in an “up” state). If the determination is made that the first command key has been depressed and released then, at stage 310, the associated left click “up” event occurs.

If the determination is made that the first command key has not been depressed and releases then, at step 320, a determination is made as whether the second command key is currently depressed (i.e., in a “down” state). In the embodiment of FIG. 1 the second command key is the tab key that is activated to become the right-click command of a conventional mouse pointing device. If the determination is made that the second command key has been depressed then, at stage 330, the associated right click “down” event occurs.

If the determination is made that the second command key is not currently depressed then, at step 340, a determination is made as whether the second command key is currently depressed and released (i.e., in an “up” state). If the determination is made that the second command key has been depressed and released then, at stage 350, the associated left click “up” event occurs.

The next eight keystroke commands of the activation/deactivation interrupt service module (steps 360, 380, 400, 420, 440, 460, 480 and 500) are associated with arrow key directives that navigate the cursor on the display to specific areas on the display. If a determination is made that the second command key has not been depressed and released then, at step 360, a determination is made as to whether the right arrow key is currently depressed (i.e., in a “down” state). If the determination is made that the right arrow key has been depressed then, at stage 370, the module sets the MouseRight event to begin performing right movement of the cursor.

If the determination is made that the right arrow key is not currently depressed then, at step 380, a determination is made as whether the right arrow key is released (i.e., in an “up” state). If the determination is made that the right arrow key has been released then, at stage 390, the module clears the MouseRight event to stop performing right movement of the cursor.

If a determination is made that the right arrow key is not currently depressed or has been released then, at step 400, a determination is made as to whether the left arrow key is currently depressed (i.e., in a “down” state). If the determination is made that the left arrow key has been depressed then, at stage 410, the module sets the MouseLeft event to begin performing left movement of the cursor.

If the determination is made that the left arrow key is not currently depressed then, at step 420, a determination is made as whether the left arrow key is released (i.e., in an “up” state). If the determination is made that the left arrow key has been released then, at stage 430, the module clears the MouseLeft event to stop performing right movement of the cursor.

If a determination is made that the left arrow key is not currently depressed or has been released then, at step 440, a determination is made as to whether the up arrow key is currently depressed (i.e., in a “down” state). If the determination is made that the up arrow key has been depressed then, at stage 450, the module sets the MouseUp event to begin performing upward movement of the cursor.

If the determination is made that the up arrow key is not currently depressed then, at step 460, a determination is made as whether the up arrow key is released (i.e., in an “up” state). If the determination is made that the up arrow key has been released then, at stage 470, the module clears the MouseUp event to stop performing upward movement of the cursor.

If a determination is made that the up arrow key is not currently depressed or has been released then, at step 480, a determination is made as to whether the down arrow key is currently depressed (i.e., in a “down” state). If the determination is made that the down arrow key has been depressed then, at stage 490, the module sets the MouseDown event to begin performing downward movement of the cursor.

If the determination is made that the down arrow key is not currently depressed then, at step 500, a determination is made as whether the down arrow key is released (i.e., in an “up” state). If the determination is made that the down arrow key has been released then, at stage 510, the module clears the MouseDown event to stop performing upward movement of the cursor. If a determination is made that the down arrow key is not currently depressed or has been released then the module returns to stage 220 and normal keystroke processing ensues.

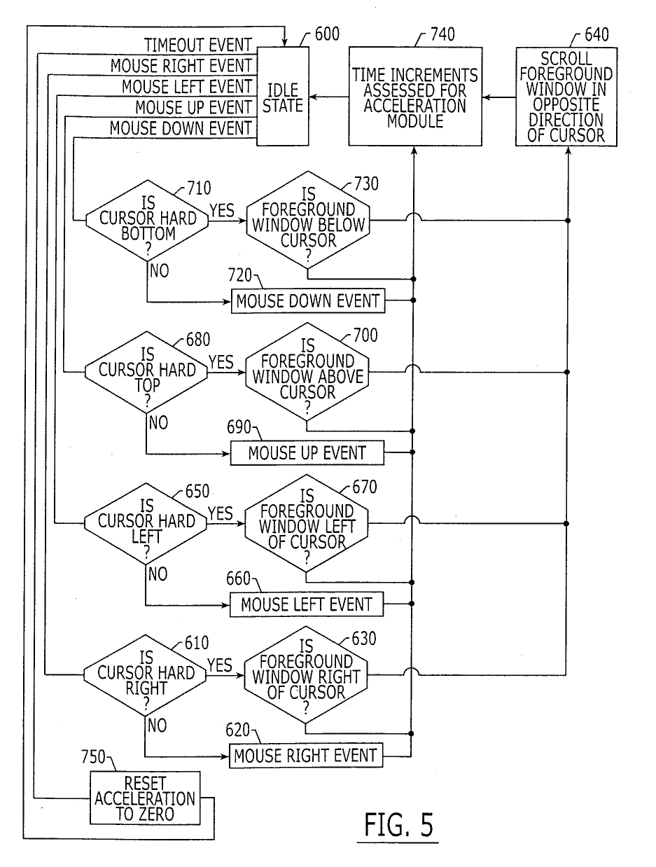

FIG. 5 is illustrative of a flow diagram of the logic flow for the cursor movement module for the pointing device, in accordance with an embodiment of the present invention. This embodiment of the invention provides for the scrolling of the foreground window when the cursor reaches an edge of the display. This novel feature of the invention allows for the foreground window (i.e., the window that the user is currently using) to be scrolled in the opposite direction of the cursor when the cursor reaches an edge of the display. This feature is particularly advantageous in devices, handheld, portable or otherwise, in which the display is less than standard VGA 640×480 (video graphics array), and particularly, in those devices in which the display is ¼ or ⅛ VGA, such as 480×320, 240×320, 240×160 and the like. For example, this feature is highly beneficial to PDT type devices that do not incorporate touch screens. In devices and systems that implement smaller displays, the associated windowing system application is likely to open in a window that is larger than the display itself. In this instance where the window is larger than the display, it may not be possible to move the window if the top window bar associated with window movement is not displayed. Thus, the scrolling feature of the present invention allows for oversized windows to be accessed and displayed in their entirety by moving the cursor to an edge of the display where the window boundary exceeds the display boundary. While this novel feature is most advantageous in devices with a smaller that standard VGA display it is not limited to portable devices or devices with smaller than VGA displays and, as such, this feature of the invention has applicability to all windowing systems.

At stage 600, the cursor movement module is at an idle state. The module moves from the idle state in accordance with the MouseRight event, MouseLeft event, MouseUp event or MouseDown event being invoked from the flow of the logic of FIG. 4. If the MouseRight event has been set (stage 370 of FIG. 4) then, at step 610, a determination is made as to whether the cursor is hard right (i.e., at the right edge of the display). If the determination is made that the cursor is not at hard right then, at stage 620, the cursor continues with movement in the right direction. If the determination is made that the cursor is hard right then, at step 630, a determination is made as to whether a foreground window exists to the right of the cursor. If no foreground window exists right of the cursor then no scrolling will incur. If a foreground window does exist right of the cursor then, at step 640, scrolling of the foreground window occurs in the opposite direction of the cursor movement, in this instance the foreground window scrolls to the left.

If the MouseLeft event has been set (stage 410 of FIG. 4) then, at step 650, a determination is made as to whether the cursor is hard left (i.e., at the left edge of the display). If the determination is made that the cursor is not at hard left then, at stage 660, the cursor continues with movement in the left direction. If the determination is made that the cursor is hard left then, at step 670, a determination is made as to whether a foreground window exists to the left of the cursor. If no foreground window exists left of the cursor then no scrolling will incur. If a foreground window does exist left of the cursor then, at step 640, scrolling of the foreground window occurs in the opposite direction of the cursor movement, in this instance the foreground window scrolls to the right.

If the MouseUp event has been set (stage 450 of FIG. 4) then, at step 680, a determination is made as to whether the cursor is hard top (i.e., at the top edge of the display). If the determination is made that the cursor is not at hard top then, at stage 690, the cursor continues with movement in the upward direction. If the determination is made that the cursor is hard top then, at step 700, a determination is made as to whether a foreground window exists above the cursor. If no foreground window exists above the cursor then no scrolling will incur. If a foreground window does exist above the cursor then, at step 640, scrolling of the foreground window occurs in the opposite direction of the cursor movement, in this instance the foreground window scrolls downward.

If the MouseDown event has been set (stage 490 of FIG. 4) then, at step 710, a determination is made as to whether the cursor is hard bottom (i.e., at the bottom edge of the display). If the determination is made that the cursor is not at hard bottom then, at stage 720, the cursor continues with movement in the downward direction. If the determination is made that the cursor is bottom then, at step 730, a determination is made as to whether a foreground window exists below the cursor. If no foreground window exists below the cursor then no scrolling will incur. If a foreground window does exist below the cursor then, at step 640, scrolling of the foreground window occurs in the opposite direction of the cursor movement, in this instance the foreground window scrolls upward.

Additionally, the cursor movement module of the present invention will typically implement a module for accelerating the speed of the cursor movement as a function of the duration of time for which the arrow key has been depressed. This allows the cursor to move in a fine manner if the arrow keys are depressed in a non-continuous fashion or a course/rapid manner if the arrow keys are depressed in a continual fashion. At step 740 of the logic flow of FIG. 5 time increments are assessed for the acceleration module. At specified predetermined time increments the cursor will begin moving at accelerated rates. The acceleration rate will be reset to zero, at stage 750, if the predetermined timeout event occurs. The timeout event will begin at the idle state, stage 600. In this instance, it may be possible, depending on the predetermined time increment of the timeout event, for an arrow key that has been depressed for a time increment that triggered acceleration to be released and then quickly depressed again without the timeout event occurring. As such, in this scenario when the arrow key is depressed again it will move at the accelerated rate.

The present invention provides for a pointing device that can be implemented in handheld devices and provides the user with an efficient and effective means of pointing to objects on the display and sending commands to the windowing system. By providing for a pointing device that is activated and deactivated on the keyboard, the pointing device of the present invention can minimize space occupancy on the keyboard or face of the device. The pointing device addresses the issues related to application window size and increasingly smaller displays, by implementing a novel scrolling routine that allows the user to access the data in oversized windowed applications without continually having to move the window to accommodate the small area of the display. The pointing device herein described is easy to activate, straightforward in operation and is capable of uncomplicated navigation of the displayed foreground window, as such the device provides the user with an efficient means of operating a handheld device that implements a windowing system.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A portable data terminal that implements a windowing system, the portable data terminal comprising:
a processing unit disposed in a portable data terminal;
a keyboard having multiple keyboard elements, the multiple keyboard elements in communication with the processing unit;
a display in communication with the processing unit that displays applications in window format; and
an activation means in communication with the processing unit that activates and deactivates an application cursor on the display.

2. The portable data terminal of claim 1, further comprising predetermined multifunctional keys disposed on the keyboard that are activated and deactivated by the activation means for the purpose of controlling commands to the application cursor on the display.

3. The portable data terminal of claim 1, further comprising one or more directional elements disposed on the keyboard that are activated and deactivated by the activation means to control directional navigation of the cursor.

4. The portable data terminal of claim 3, wherein the one or more directional elements further comprise one or more arrow keys.

5. The portable data terminal of claim 1, further comprising one or more one or more command keys that are activated and deactivated by the activation means to control pointing device commands.

6. The portable data terminal of claim 5, wherein the pointing device commands include commands equivalent to right-click and left-click commands of a mouse pointing device.

7. The portable data terminal of claim 5, wherein the one or more command keys further comprise a first command key that is activated to control right-click commands and a second command key that is activated to control left-click commands.

8. The portable data terminal of claim 5, wherein the activation means further comprises an activation key disposed on the keyboard.

9. The portable data terminal of claim 1, further comprising an imager in communication with the processing unit.

10. The portable data terminal of claim 1, further comprising a bar code reader in communication with the processing unit that reads bar code symbology.

11. The portable data terminal of claim 1, wherein the one or more directional elements provides a means for accelerated cursor navigation.

12. The portable data terminal of claim 1, wherein the one or more directional elements provide accelerated cursor navigation by continuously engaging a directional element.

13. The portable data terminal of claim 1, wherein the one or more directional elements provides a means for navigating the cursor to a predetermined location on the display to provide automatic scrolling of the foreground window.

14. A data processing system, the system comprising:
a processing unit disposed within the data processing system;
a display in communication with the processing unit that displays applications in window format and displays a cursor;
a pointing device for directing the navigation of the cursor about the display; and
a pointing device module that controls the navigation of the cursor based on commands sent from the pointing device, wherein the pointing device module provides for a routine to automatically scroll the entirety of a foreground application window when the cursor is navigated by the pointing device to a predetermined position on the display to allow for panning of the display around the foreground application window.

15. The data processing system of claim 14, wherein the data processing system is a portable data processing system.

16. The data processing system of claim 14, wherein the display has a standard resolution size smaller than 640 pixels by 480 pixels.

17. The data processing system of claim 14, wherein the display has a resolution size chosen from the group consisting of 480 pixels by 320 pixels, 240 pixels by 320 pixels and 240 pixels by 160 pixels.

18. The data processing system of claim 14, wherein the pointing device module further comprises an acceleration routine to accelerate the navigation of the pointer upon enabling a keyboard command.

19. A pointing device module implemented in a windowing system-based data processing system for controlling navigation of a cursor on an associated display, the module comprising:
means for navigating a cursor about a display;
means for invoking windowing system commands, wherein the commands are associated with a location of the cursor on the display; and
means for scrolling the entirety of a foreground application window when the cursor is navigated to an edge of the display.

20. The module of claim 20, further comprising means for accelerating the rate of navigation of the cursor.

21. A method for activating and navigating a windowing system-based cursor on a display of a portable data terminal, the method comprising:
engaging an activation means on the portable data terminal;
activating a keyboard-based pointing device in response to engaging the activation means;
displaying an application cursor on a data terminal display in response to engaging the activation means; and
engaging a keyboard-based pointing device directional element to navigate the cursor about the display.

22. The method of claim 21, wherein the step of engaging an activation means further comprises engaging an activation key on a keyboard of the portable data terminal.

23. The method of claim 21, further comprising the step of engaging, continuously, the directional element to accelerate the navigation of the cursor about the display.

24. The method of claim 21, further comprising the step of engaging the directional element to navigate the cursor to a predetermined area of the display to invoke scrolling of the foreground application window.

25. The method of claim 21, further comprising the step of disengaging the activation means to deactivate the keyboard-based pointing device and remove the display of the application cursor from the portable data terminal display.

26. A method for operating a windowing system-based application on a portable data terminal:
engaging an activation means associated with the portable data terminal to activate a keyboard-based pointing device, the keyboard-based pointing device including one or more directional elements and one or more command keys;
engaging a directional element disposed on a portable data terminal keyboard to navigate a cursor to a desired location within a displayed application; and
engaging a control key disposed on the portable data terminal to invoke an application command.

27. The method of claim 26, wherein the step of engaging a directional element further comprises engaging, continuously, a directional element to accelerate navigation of the cursor on the display.

28. The method of claim 26, wherein the step of engaging a directional element further comprises engaging a directional element to navigate the cursor to a predetermined location on the display to provide for automatic scrolling of the entirety of a foreground application window.

29. A method for automatically scrolling the display of a foreground window on a display associated with a data processing device, the method comprising:
navigating a cursor to a predetermined location on the display; and
scrolling, automatically, the entirety of a foreground application window to effectively pan the display around the foreground application window.

30. The method of claim 29, wherein navigating the cursor to a predetermined location further comprises navigating the pointer to an edge of the display.

31. The method of claim 30, wherein scrolling, automatically, the entirety of a foreground window further comprises scrolling in the direction of the edge of the display that the cursor is navigated toward.
